(19) United States
(12) Patent Application Publication
(10) Pub. No.: US 2019/0355280 A1
(43) Pub. Date: Nov. 21, 2019

(54) ECHOGENIC ORGAN REPLICA AND METHOD OF MANUFACTURE USING AN ADDITIVE MANUFACTURING SYSTEM

(71) Applicant: Biomodex S.A.S., Paris (FR)

(72) Inventors: Frédéric Champ, Paris (FR); Baptiste Luciani, Cachan (FR); Clément Jubert, Paris (FR); Noémi Renaudin, Boulogne-Billancourt (FR)

(21) Appl. No.: 16/417,151

(22) Filed: May 20, 2019

Related U.S. Application Data
(60) Provisional application No. 62/674,585, filed on May 21, 2018.

(51) Int. Cl. G09B 23/28; B33Y 50/02; B33Y 70/00; B33Y 80/00; B29C 64/393

(52) U.S. Cl. CPC G09B 23/286; B33Y 50/02; B33Y 10/00; B33Y 80/00; B29C 64/393; B33Y 70/00

(57) ABSTRACT

An echogenic organ replica and method of manufacture using an additive manufacturing system are provided. The echogenic organ replica includes at least one lower acoustic impedance material and a higher acoustic impedance material distributed within the at least one lower acoustic impedance material. The resulting echogenicity of the echogenic organ replica varies in three dimensions across each of the one or more locations to substantially replicate an echogenicity associated with corresponding locations of in vivo organ tissue.

### RELATED APPLICATIONS

The present application claims the benefit of and priority to U.S. Patent Application No. 62/674,585, filed on May 21, 2018, the entire contents or which are hereby incorporated by reference for all purposes.

### BACKGROUND

Organ replicas are used to simulate anatomical characteristics and/or mechanical functions associated with an in vivo organ of a human or an animal. Organ replicas manufactured using an additive manufacturing system can simulate a variety of in vivo conditions corresponding to the organ to be simulated or replicated for a specific patient.

### SUMMARY

According to one aspect, the disclosure relates to an echogenic organ replica. The echogenic organ replica includes a lower acoustic impedance material and at least one higher acoustic impedance material distributed within the lower acoustic impedance material. At different locations of the echogenic organ replica, the at least one higher acoustic impedance material is distributed within the lower acoustic impedance material with material distributions that vary in three dimensions through the organ replica resulting in an organ replica whose echogenicity varies in three dimensions to replicate the three-dimensional variation of echogenicity associated with corresponding in vivo organ tissue.

In some implementations, the at least one higher acoustic impedance material includes a first higher acoustic impedance material and a second higher acoustic impedance material, the second higher acoustic impedance material has a different elasticity than the first higher acoustic impedance material. In some implementations, the arrangement of the first higher acoustic impedance material and the second higher acoustic impedance material is such that the echogenic organ replica has, across its surface, substantially similar elasticity of corresponding locations of the in vivo organ tissue replicated by the echogenic organ replica in view of one or more organs surrounding the in vivo organ tissue.

In some implementations the at least one higher acoustic impedance material is distributed within the lower acoustic impedance material. In some implementations the at least one higher acoustic impedance material is distributed within the lower acoustic impedance material as a plurality of microbeads distributed within the lower acoustic impedance material. In some implementations the diameter (or smallest dimension if not spherical) of the microbeads is between 0.01 mm and 1.0 mm. In some implementations the amount of higher acoustic impedance material distributed within the lower acoustic impedance material at a first location varies from the amount of higher acoustic impedance material distributed within the lower acoustic impedance material at a second location.

In some implementations, the higher acoustic impedance material is distributed within the at least one lower acoustic impedance material such that the higher acoustic impedance material forms a lattice structure at the one or more locations of the echogenic organ replica. In some implementations, the lattice structure at a first location has a first pitch resulting in a first echogenicity and the lattice structure at a second location has a second pitch resulting in a second echogenicity. In some implementations, the lower acoustic impedance material includes a non-polymerized material including at least one of water, a gel, an ion, or a bio-molecule.

In some implementations, the at least one higher acoustic impedance material is distributed within the lower acoustic impedance material such that the resulting spatial density of higher acoustic impedance material within the lower acoustic impedance material ranges from about 0.1% to 10.0% of the volume of the lower acoustic impedance material at the one or more locations of the echogenic organ replica. In some implementations, the higher acoustic impedance material is distributed within the lower acoustic impedance material such that the spatial density of higher acoustic impedance material within the lower acoustic impedance material at a first location ranges from about 1.0% to 3.0% and the spatial density of higher acoustic impedance material within the lower acoustic impedance material at a second location is greater than 3.0%.

In some implementations, the lower acoustic impedance material and the at least one higher acoustic impedance material include 3D printed materials. In some implementations, the in vivo organ tissue includes organ tissue of one or more human or animal organs including a heart, a lung, a stomach, a urinary bladder, a bone, a lymph node, a larynx, a pharynx, vasculature, a spinal column, an intestine, a colon, a rectum, or an eye.

According to another aspect, the disclosure relates to a method of manufacturing an echogenic organ replica. The method includes obtaining medical image data of an organ within a specific patient. The method further includes receiving, by an additive manufacturing system, one or more data files specifying a configuration of one or more materials to be deposited by the additive manufacturing system. The method further includes forming, by the additive manufacturing system, the echogenic organ replica by dispensing, based on the received one or more data files, at least one higher acoustic impedance material distributed within a lower acoustic impedance material. At different locations of the echogenic organ replica, the at least one higher acoustic impedance material is distributed within the lower acoustic impedance material with material distributions that vary in three dimensions through the organ replica and resulting in an organ replica whose echogenicity varies in three dimensions to replicate the three-dimensional variation of echogenicity associated with corresponding in vivo organ tissue.

In some implementations, one material of the at least one higher acoustic impedance material has a first elasticity and another material of the at least one higher acoustic impedance materials has a second elasticity different than the first elasticity. In some implementations, the at least one higher acoustic impedance material is distributed within the lower acoustic impedance material. In some implementations, the at least one higher acoustic impedance material is distributed within the lower acoustic impedance material as a plurality of microbeads distributed within the lower acoustic impedance material. In some implementations, the diameter (or smallest dimension if not spherical) of the microbeads is between 0.01 mm and 1.0 mm. In some implementations, the amount of the at least one higher acoustic impedance material distributed within the lower acoustic impedance material at a first location varies from the amount of higher acoustic impedance material distributed within the lower acoustic impedance material at a second location.

In some implementations, the at least one higher acoustic impedance material is distributed within the lower acoustic impedance material such that the at least one higher acoustic impedance material forms a lattice structure at the one or more locations of the echogenic organ replica. In some implementations, the lattice structure at a first location has a first pitch resulting in a first echogenicity at the first location and the lattice structure at a second location has a second pitch resulting in a second echogenicity at the second location. In some implementations, the lower acoustic impedance material includes a non-polymerized material including at least one of water, a gel, an ion, or a bio-molecule.

In some implementations, the at least one higher acoustic impedance material is distributed within the lower acoustic impedance material such that the resulting spatial density of at least one higher acoustic impedance material within the lower acoustic impedance material ranges from about 0.1% to 10.0% of the volume of the lower acoustic impedance material at one or more locations of the echogenic organ replica. In some implementations, the at least one higher acoustic impedance material is distributed within the lower acoustic impedance material such that the spatial density of the at least one higher acoustic impedance material within the lower acoustic impedance material at a first location ranges from about 1.0% to 3.0% and the spatial density of the at least one higher acoustic impedance material within the lower acoustic impedance material at a second location is greater than 3.0%.

In some implementations, the local mechanical properties of the at least one higher impedance material and the lower acoustic impedance material vary to replicate mechanical feedback exerted on the organ being replicated by one or more organ tissues surrounding the in vivo organ tissue. In some implementations, the one or more organ tissues surrounding the organ being replicated, for which mechanical feedback is exerted on the organ, includes at least one of bones or joints.

In some implementations, the organ includes a part of a larger organ. In some implementations, the organ includes an artery. In some implementations, the organ includes a heart, a lung, a stomach, a urinary bladder, a bone, a lymph node, a larynx, a pharynx, muscle vasculature, a spinal column, an intestine, a colon, a rectum, or an eye.

### BRIEF DESCRIPTION OF THE DRAWINGS

The above and related objects, features, and advantages of the present disclosure will be more fully understood by reference to the following detailed description, when taken in conjunction with the following figures, wherein:

FIG. 1 is a diagram of an example system for manufacturing an echogenic organ replica using an additive manufacturing system.

FIG. 2 is a diagram of a portion of an echogenic organ replica including a plurality of organ tissue materials arranged as a plurality of material layers.

FIGS. 3A-3D are diagrams showing a plurality of echogenic organ replica material arrangements according to some implementations.

FIG. 4A is a diagram showing a plurality of echogenic organ replica material distributions according to some implementations.

FIG. 4B is a series of ultrasound images showing a plurality of echogenic results associated with the plurality of echogenic organ replica material distributions according to some implementations.

FIG. 4C demonstrates how the ultrasound aspect of an echogenic organ replica can also be modulated by altering the specific arrangement of higher acoustic material impedance materials within a volume of lower acoustic impedance materials.

FIG. 4D shows how more defined local variations of high acoustic impedance material can achieve defined ultrasound imaging results.

FIG. 5A is a series of ultrasound images comparing the echogenicity of a patient's echogenic organ replica with the echogenicity of the patient's in vivo organ in response to tissue tenting.

FIG. 5B is a series of ultrasound images comparing the echogenicity of a patient's echogenic organ replica with the echogenicity of the patient's in vivo organ in response to appendage detection.

FIG. 6 is a flow chart representing an example method of manufacturing an echogenic organ replica according to some implementations.

FIG. 7 is a block diagram of an example computing system.

### DETAILED DESCRIPTION

Three-dimensional (3D) printing has recently evolved as a rapid prototyping process to construct a variety of three dimensional objects by depositing, joining, or solidifying materials under computer-aided control. Additive manufacturing describes a broader approach to 3D printing which is typically associated with industrial scale production of complex, multi-component objects such as clocks, medical devices, turbine engine parts, and automotive components. Additive manufacturing systems generate three dimensional objects by successively adding or depositing one or more materials in multiple layers based on digital model data representing the object to be generated. Advancements in additive manufacturing technologies and the materials used within additive manufacturing systems have enabled further applications in the medical field including tissue and organ fabrication, hearing aid manufacture, customization of prosthetics and implants, anatomical organ modeling, drug delivery mechanism research, and tissue generation.

Organ replicas, also known as organ models or organ simulation devices, may be manufactured using an additive manufacturing system with a variety of materials and methods to create a physical object on which medical practitioners can conduct simulated experimental, diagnostic or clinical tasks. For example, organ replicas can enable medical practitioners to practice a particular procedure or therapeutic treatment such as catheter angiography, transesophageal echocardiograms, or organ and joint implantation procedures in advance of performing the procedure on a living human or animal patient. Practicing these kinds of procedures on an organ model including generic anatomical features or on a cadaver organ provides the medical practitioner with a limited understanding of the unique anatomical variances or anomalies that may be present in a specific patient and thus increases the risk and complexity of performing the procedure on the specific patient.

Advances in medical imaging and materials technologies have made it possible to utilize additive manufacturing systems to generate an organ replica possessing the unique anatomic and structural features of a specific patient's organ. However, it is difficult to create an organ replica such that the materials of the organ replica accurately simulate or correspond to the in vivo properties of the organ tissue being replicated. For example, in vivo organ tissue properties such as elasticity, permeability, echogenicity, and density are difficult to replicate in organ replicas created using additive manufacturing systems.

In addition, many minimally invasive medical procedures are often performed using ultrasound imaging so that a medical practitioner may view and be guided by ultrasound imagery to safely perform the particular treatment or procedure. An echogenic organ replica allows the medical practitioner to practice the specific procedure on an echogenically and anatomically accurate model of the patient's organ or organ tissue using the same ultrasound imaging methodology and equipment as would be used in an actual procedure on the patient, thereby replicating not only the patient's specific organ but also replicating the clinical treatment environment and methods that would be used during the specific procedure. A novel solution is required to generate echogenic organ replicas using additive manufacturing systems and materials based on medical imaging data obtained from a variety of imaging modalities.

A solution to this problem, presented herein, includes an echogenic organ replica and methods of manufacturing the echogenic organ replica using an additive manufacturing system and a plurality of materials. An additive manufacturing system enables the echogenic organ replica to be generated using a variety of materials such that the resulting echogenic organ replica possesses the anatomical characteristics, echogenic and/or mechanical properties associated with the in vivo organ or organ tissue being simulated or replicated for a specific patient. The echogenic organ replica may be formed such that the plurality of materials is deposited in one or more material layers. Each material layer may include one or more materials of differing acoustic impedance. The placement of materials of differing acoustic impedance adjacent to one another results in an acoustic discontinuity, which leads to a change in echogenicity. At one or more locations of the echogenic organ replica, the plurality of materials may be deposited in such a manner as to simulate the echogenicity of the corresponding organ tissue being replicated in three-dimensions.

Echogenicity refers to the ability of a material or an organ or organ tissue to reflect ultrasound energy. Higher echogenicity is a result of increased reflection of ultrasound energy by the material, organ or organ tissue. A material, organ, or organ tissue may be described as hyper-echogenic when exhibiting increased reflection of ultrasound energy. Lower echogenicity results from decreased reflection (and increased transmission) of ultrasound energy by a material, organ, or organ tissue. A material, organ, or organ tissue may be described as hypo-echogenic when exhibiting decreased reflection (or increased transmission) of ultrasound energy.

Although echogenicity is a relative intensity property and is not defined by a strict standard, the following definitions are generally accepted within the field of medical imaging. A hypo-echogenic material is generally considered to be a material which produces a decreased response (or a decreased sound echo) when ultrasounds energy is applied to the material. When viewed using ultrasound imaging, the hypo-echogenic material is represented as a darker color. Hypo-echogenic materials transmit and/or diffuse the applied ultrasound energy and do not reflect or return the applied ultrasound energy. In contrast, a hyper-echogenic material is generally considered to be a material which produces an increased response or increased sound echo when ultrasound energy is applied to the material. When viewed using ultrasound imaging, the hyper-echogenic material is represented as a lighter color. Hyper-echogenic materials reflect the applied ultrasound energy and do not diffuse (or diffuse to a lesser extent) applied ultrasound energy. An anechogenic material is a material which produces no response to applied ultrasound energy. When viewed using ultrasound energy, the anoechogenic material will appear completely black as all of the applied ultrasound energy is transmitted completely through the anechogenic material. Although the descriptions of echogenicity provided herein are made in reference to materials, the same descriptions of echogenicity can be applied to organs, organ tissues, or portions of an organ tissues within human or animal bodies.

The plurality of materials may include a higher acoustic impedance materials and lower acoustic impedance materials.

The plurality of materials may also include a variety of material mixtures in which specified amounts of higher acoustic impedance material are distributed, suspended, or encapsulated within amounts of lower acoustic impedance material (or vice versa). In some implementations, the material mixtures may include varying proportions of higher acoustic impedance material distributed within the lower acoustic impedance material in order to achieve a predetermined spatial density of higher acoustic impedance material within the lower acoustic impedance material. In some implementations, the material mixtures may include varying proportions of higher acoustic impedance material distributed within the lower acoustic impedance material in order to achieve a predetermined echogenicity at one or more locations of the echogenic organ replica. The higher acoustic impedance material may be distributed within the lower acoustic impedance material as a suspension. For example, the higher acoustic impedance material may be distributed as a plurality of microbeads or microfibers that are suspended within the lower acoustic impedance material. The microbeads may be spherical, ovoid, or rectangular, or have any other regular or irregular shape. The density of the higher acoustic impedance material within the lower acoustic impedance material may range from 0% for highly hypo-echogenic regions of a replicated organ or organ tissue to 10% or more for more hyper-echogenic regions of a replicated organ. Spatial echogencity gradients can be achieved in three dimensions by depositing material of increasing or decreasing density of higher acoustic impedance material across a region of a replicated tissue or organ.

In some implementations, the echogenicity of replicated organ tissue can be varied by use of different combinations of materials in addition to or instead of varying the density of higher acoustic impedance materials in a suspension. For example, for regions of lower echogenicity, the difference in acoustic impedance between the lower acoustic impedance material and the higher acoustic impedance material suspended or distributed in the lower acoustic material may be less than the differences in acoustic impedances of the materials used in regions of greater echogenicity. Accordingly, in various implementations, the differences in acoustic impedance between the lower acoustic impedance material and the higher acoustic impedance material may range from as little as about 10% to as much as 25 times. For example, the higher acoustic impedance material may have an acoustic impedance which is 10% higher, 100% higher, 500% higher, 1000% higher or even 2500% higher than the acoustic impedance of the lower acoustic impedance material. Greater differences in acoustic impedance result in increased echogenicity.

In some implementations, the echogenic organ replica includes larger structures of higher acoustic impedance material embedded in and completely surrounded by lower acoustic impedance material. In some implementations, the higher acoustic impedance material is embedded within the lower acoustic impedance material to form a lattice or matrix structure. The lattice structure may be formed as a variety of material arrangements of materials of different acoustic impedances so that the echogenicity in one or more locations varies in order to replicate the varying echogenicity of a region of organ tissue for the organ being replicated. This variation can occur in three dimensions, both across a surface of a particular organ tissue, but also through the thickness of the organ tissue. In some implementations, this variation includes a variation in the pitch of the lattice structure. In some implementations, the lattice structure may provide structural support at one or more locations of the echogenic organ replica.

In some implementations, the higher acoustic impedance material is distributed within the lower acoustic impedance material to create one or more discrete acoustic discontinuities based on the acoustic properties of in vivo organ or organ tissue to be replicated. In this way, a wide range of echogenic characteristics may be recreated at one or more locations in the echogenic organ replica. For example, a heart may have tissue portions that are more highly echogenic and thereby reflect more ultrasound energy. Other portions of the heart tissue may be less echogenic and reflect ultrasound energy poorly, thereby allowing more of the ultrasound energy to be transmitted through those portions of the heart. Still other portions of the heart are filled with blood, which is almost completely hypo-echogenic. The discrete acoustic discontinuities occur at interfaces of higher acoustic impedance material distributed within the lower acoustic impedance material to replicate three or more different levels of echogenicity apparent when examining a heart with ultrasound. While an example of a heart is described above, the echogenic organ replica may also be a replica of a lung, a stomach, a urinary bladder, a bone, a lymph node, a larynx, a pharynx, vasculature, a spinal column, an intestine, a colon, a rectum, an auditory canal or an eye.

In some implementations, the echogenic organ replica may include a plurality of materials arranged within the echogenic organ replica such that the resulting elasticity of the echogenic organ replica surface is substantially similar to corresponding locations of the in vivo organ or organ tissue being replicated. In some implementations, the resulting elasticity is based on one or more organs surrounding the in vivo organ or organ tissue being replicated. The surrounding organs may influence the elasticity of an in vivo organ. For example, portions of an artery that are longitudinally oriented along the length of a bone may have less elasticity at one or more locations in proximity to the bone because the artery is confined by the presence of the rigid bone structure. In other locations, where the artery is oriented proximal to a less rigid structure such as a membrane, muscle, fatty tissue, or a body cavity, the artery may have more elasticity.

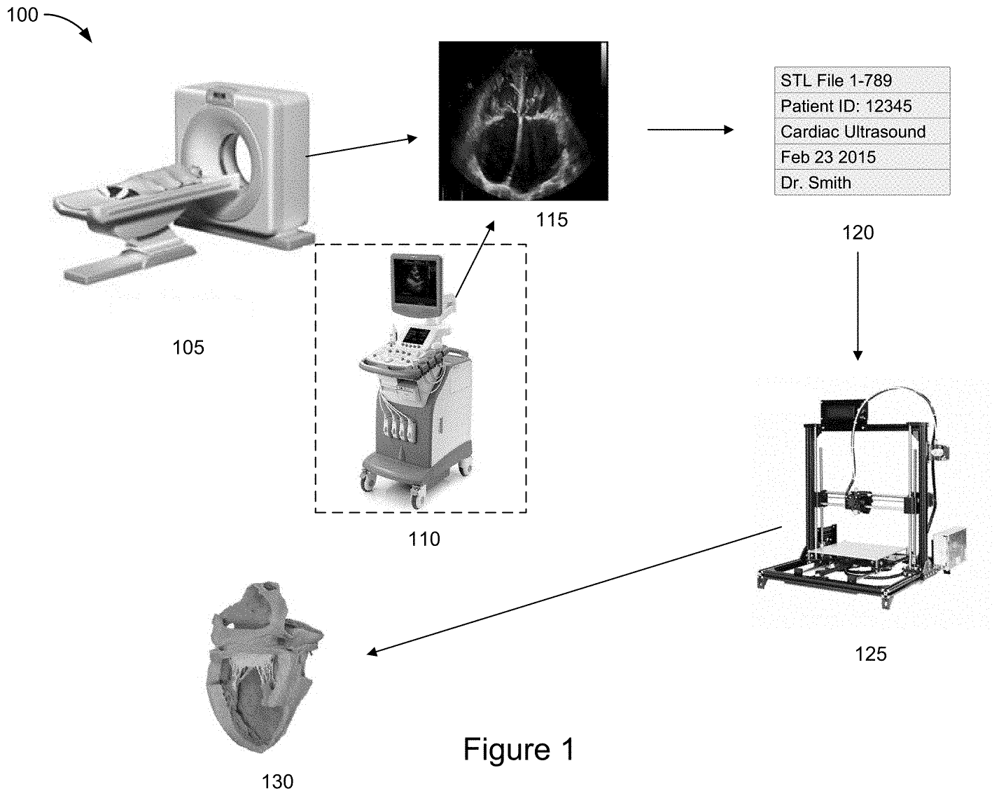

FIG. 1 is a diagram of an example system 100 for manufacturing an echogenic organ replica 130 using an additive manufacturing system 125. In broad overview, the system 100 includes a medical imaging system 105, such as a CT scanner, and optionally may include (as shown in dashed lines) an ultrasound imaging system 110. In some implementations, the system may include other medical imaging systems such as X-ray radiography, magnetic resonance imaging (MRI), or nuclear medicine functional imaging systems such as positron emission tomography and single-photon emission computed systems. The system 100 includes medical image data 115 and one or more data files 120. The system 100 also includes an additive manufacturing system 125 used to manufacture the echogenic organ replica 130.

As shown in FIG. 1, a patient participates in a medical imaging procedure utilizing a CT scanner 105. In addition, or alternatively, the patient participates in a medical imaging procedure utilizing an ultrasound imaging device 110. Medical image data 115 is generated as a result of either medical imaging procedure. The patient's medical image data 115 is generated based on the specific organ or organ tissue identified by a medical practitioner to be imaged using either the CT scanner 105 or the ultrasound imaging device 110. The medical image data 115 is processed to generate one or more data files 120.

The one or more data files 120 include patient specific data corresponding to the organ or organ tissue imaged using either the CT scanner 105 and/or the ultrasound imaging device 110. The one or more data files 120 may be generated from the medical image data 115 by processing the medical image data. For example, the processing may include converting the medical image data 115 from a common file format used in medical imaging procedures, such as the digital imaging and communications in medicine (DICOM) file format, into one or more data files formatted in the stereolithography (STL) or other file format (e.g., OBJ, PLY, X3G, or FBX) suitable for use in an additive manufacturing system. In some implementations, the image data can be converted into a stack of binary image formats, such as Bitmap or RAW, for use in other additive manufacturing systems.

As shown in FIG. 1, the one or more data files 120 are received by an additive manufacturing system 125. The one or more data files 120 are processed by the additive manufacturing system 125 to manufacture the echogenic organ replica 130. The additive manufacturing system 125 may utilize a variety of additive manufacturing techniques such as stereolithography, fused deposition modeling, 3D inkjet printing, also known as Polyjet™ (Stratasys Ltd., North America), continuous liquid interface production (CLIP) or the like. The additive manufacturing system 125 generates the echogenic organ replica 130 by sequentially layering and/or joining a plurality of materials associated with a 3D organ model included in the one or more data files 120. The additive manufacturing system 125 may be configured to produce a 3D object including a plurality of materials with differing physical properties such as color, density, elasticity, and acoustic impedance based on the one or more data files 120. For example, as shown in FIG. 1, the additive manufacturing system 125 produces an echogenic organ replica 130.

The echogenic organ replica 130 is a 3D model of a specific patient's organ, a heart, as shown in FIG. 1. Other suitable organs for replication include, without limitation, a lung, a stomach, a urinary bladder, a bone, a lymph node, a larynx, a pharynx, vasculature, a spinal column, an intestine, a colon, a rectum, auditory canal or an eye. The echogenic organ replica 130 includes a plurality of echogenic materials deposited by the additive manufacturing system 125 in accordance with the specifications of the volumetric or 3D model included in the one or more data files 120 received by the additive manufacturing system 125. The echogenic organ replica 130 includes a plurality of 3D printed materials, including a higher acoustic impedance material and at least one lower acoustic impedance material. Additional higher or lower acoustic impedance materials may be included in the echogenic organ replica 130 to provide varying levels of echogenicity across and through the organ replica 130. The additional materials may include materials which have different material properties such as elasticity or density. In some implementations, the echogenic organ replica 130 may include a lattice structure or other arrangement of materials created by enclosing a higher acoustic impedance material within at least one lower acoustic impedance material. In addition, or alternatively, in some implementations, the lattice structure may be formed within the organ replica 130 as an exemplary material arrangement for the purpose of varying the spatial density of the plurality of higher acoustic impedance and lower acoustic impedance materials in the organ replica 130 at one or more locations. Varying the spatial density of the materials at one or more locations of the echogenic organ replica 130 may be performed to map, model, simulate, or otherwise replicate the varying echogenicity and mechanical properties at corresponding locations of the in vivo organ being replicated. In some implementations, the echogenic organ replica 130 may include a sacrificial material which is formed using a lower acoustic impedance material such as water, a gel, or a bio-molecule. In these implementations, the sacrificial material may be removed from the echogenic organ replica 130 after manufacture by heat or by application of an agent to dissolve the non-polymerized material. Such removal is used to form lumens with replicated vasculature and cavities (such as heart chambers) within replicated organs or tissues. In some implementations, to avoid the removal of the lower-acoustic impedance materials where such material is used to surround or suspend higher-acoustic impedance materials, and to increase the structural integrity of the organ replica 130, larger portions, and in some cases, the entirety, of the organ replica may be encased or surrounded by a thin layer (e.g., on the order of only a few hundred microns thick) of higher acoustic impedance material that is not susceptible to removal during a post-manufacturing cleaning process.

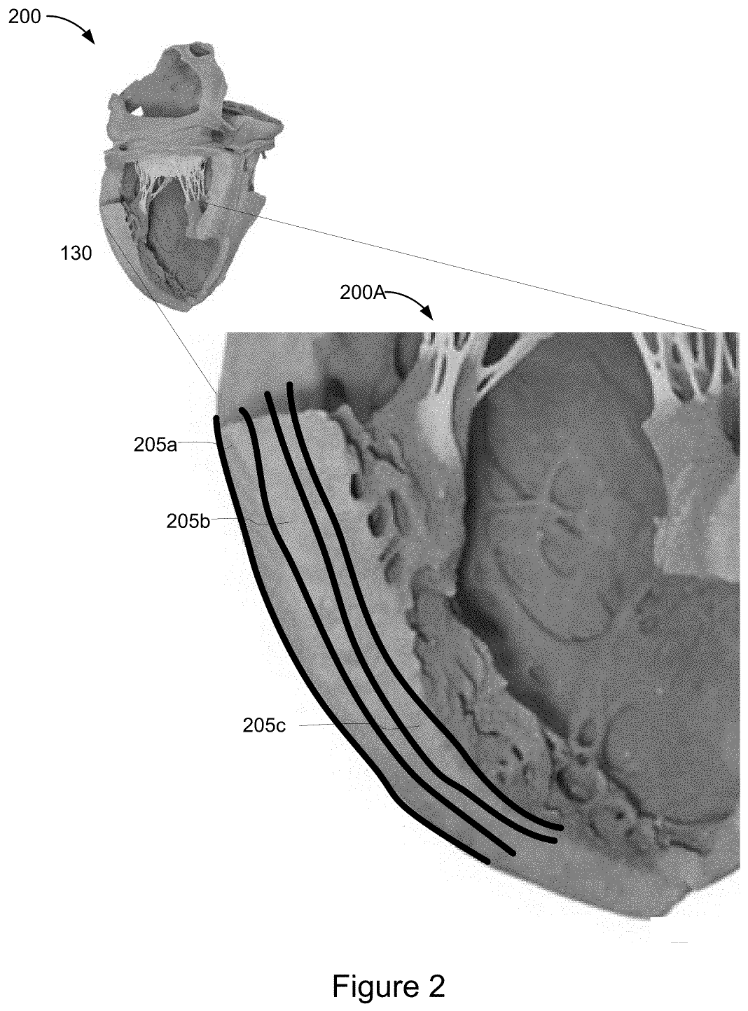

FIG. 2 is a diagram 200 of an echogenic organ replica, such as echogenic organ replica 130 shown in FIG. 1. The echogenic organ replica 130 shown in FIG. 2 includes a plurality of replica tissue layers 205a-205c, each of which may be generally referred to as a replica tissue layer 205. As shown in diagram 200 of FIG. 2, the echogenic organ replica 130 is depicted with a cut-away view 200A to illustrate a portion of the echogenic organ replica 130 which includes replica tissue layers, an outer replica tissue layer 205a, a middle replica tissue layer 205b, and an inner replica tissue layer 205c (generally replica tissue layers 205).

As depicted in FIG. 2, the replica tissue layers 205 each represent multiple layers of deposited materials which collectively (based on the relative distribution of the various materials included in each layer) form an echogenicity that replicates the echogenicity of the in vivo tissue layer. Each replica tissue layer 205 may correspond to an anatomic layer of the organ being replicated by the echogenic organ replica 130. For example, the wall of a heart has three anatomic layers. The epicardium (the external layer), the myocardium (the middle layer), and the endocardium (the inner layer). As shown in FIG. 2, the cut-away view of the echogenic organ replica 130 includes three replica tissue layers 205 modeling the corresponding anatomic shape and echogenic properties of the three anatomic layers of an in vivo heart. In some other implementations, the replica tissue layers 205 may also demonstrate mechanical characteristics that mimic those of the in vivo organ structure being replicated.

It should be noted that each replica tissue layer 205 may be composed of portions of multiple deposition layers. As used herein, a deposition layer refers to a single layer of material deposited by an additive manufacturing device across a common elevation from the base of printed object. Such deposition layers may not correspond to a single structural material layer. For example, if the organ replica 200 were fabricated from the bottom of the figure to the top in the orientation shown in FIG. 2, a deposition layer would form a horizontal cross-section of the organ replica 200, including material from the outer material layer 205a, middle layer 205b, and inner layer 205c.

Each replica tissue layer 205 may be formed by the additive manufacturing system 125 based on processing the one or more received data files 120 shown in FIG. 1, and depositing a series of depositions layers, each including one or more materials having the same or varying acoustic impedances. In some implementations, a replica tissue layer 205 may include one or more materials having the same acoustic impedance, for example, where the replica tissue layer replicates tissue which is hypo-echogenetic. Another replica tissue layer 205 may include materials of varying acoustic impedance, resulting in acoustic discontinuities and ultrasound reflection to mimic hyper-echogenic tissues.

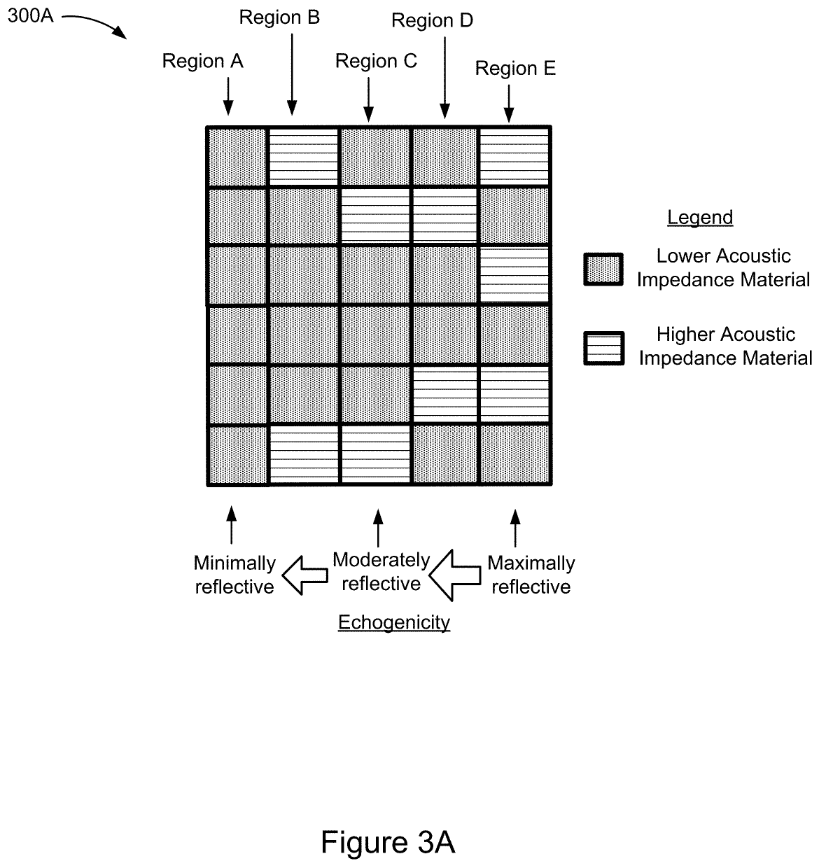

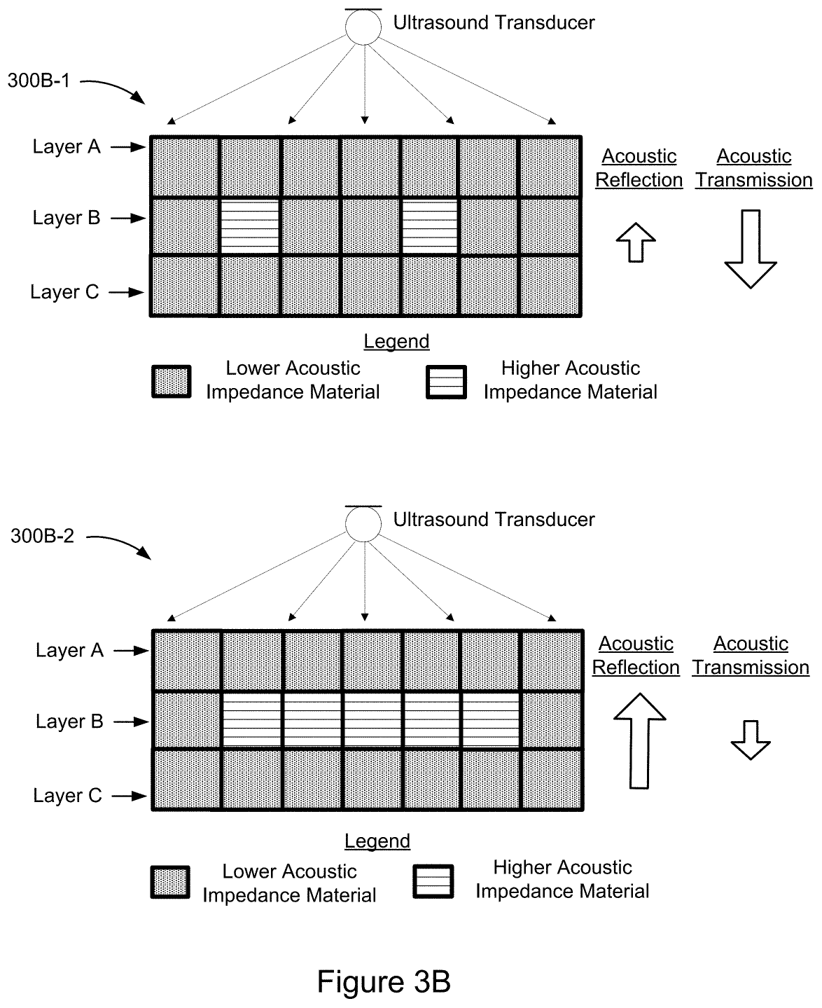

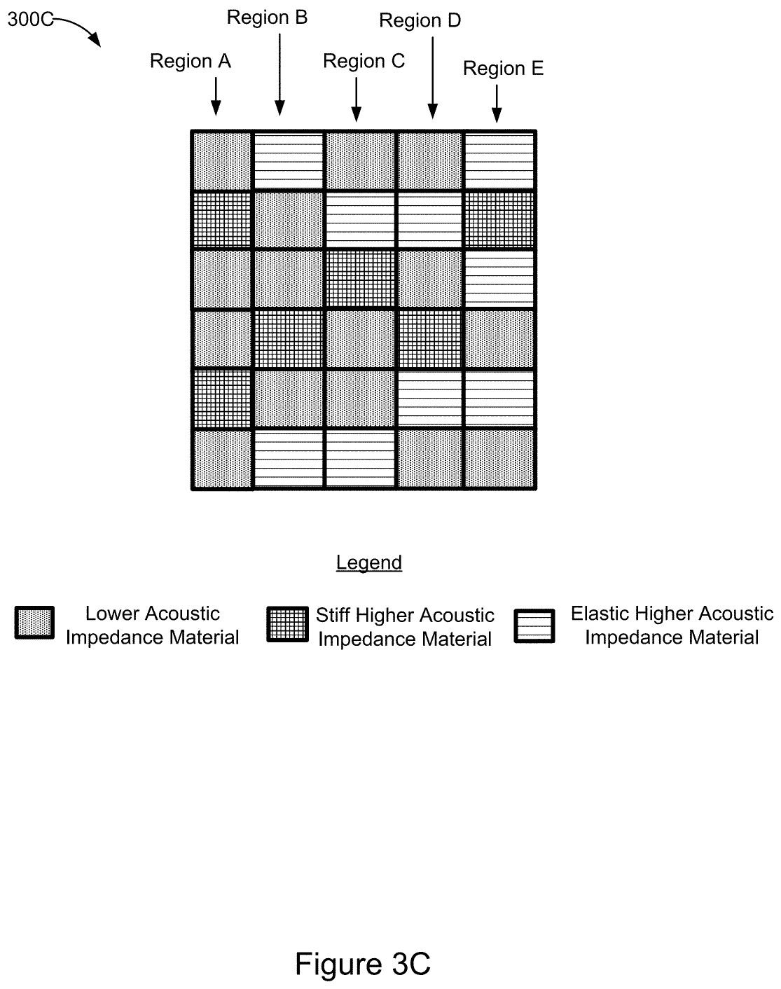

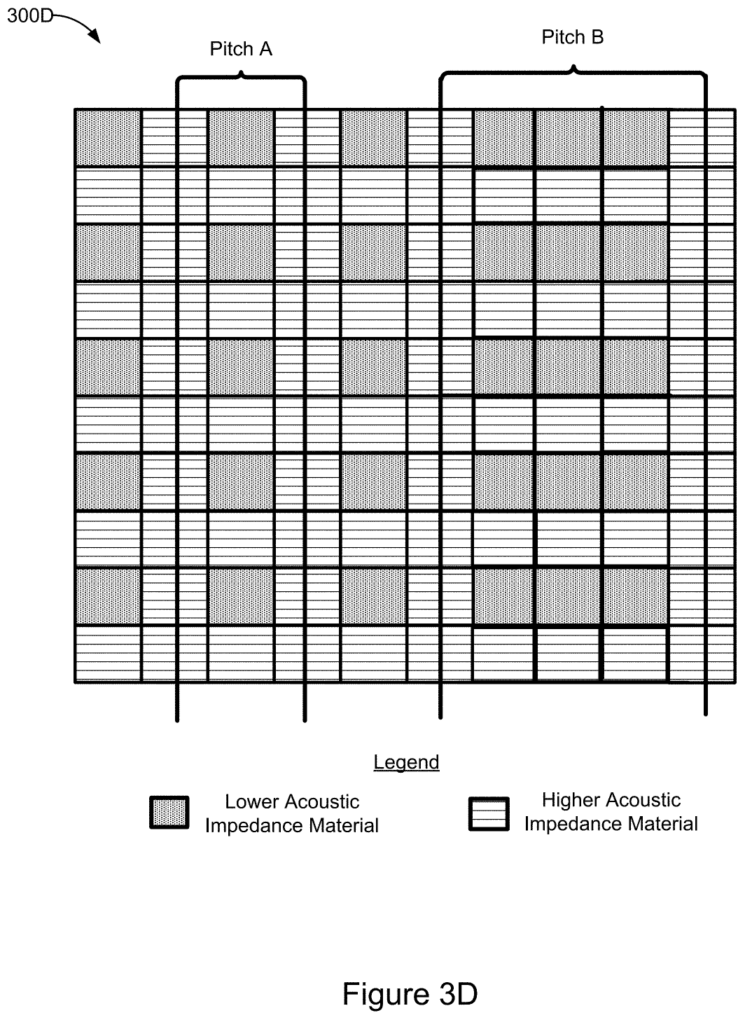

For example, as shown in FIG. 2, the outer replica tissue layer 205a may be formed to replicate the outermost layer of the wall of a patient's heart. The outer replica tissue layer 205a may be formed from a single material distribution, such that the spatial distribution of higher acoustic impedance material within a volume of lower acoustic impedance material is substantially constant though the replica tissue layer. As described further below, the material distribution can be formed through the suspension or distribution of microbeads or microfibers of higher acoustic impedance material being substantially evenly suspended or distributed within a given volume of lower acoustic impedance material. Alternatively, the distribution may be formed by dispensing of higher acoustic material in the form of a lattice, where lower acoustic impedance materials are dispensed to fill the voids within the lattice. A lattice having a tighter “weave” results in a greater spatial density of higher acoustic impedance material, and therefore a more hyper-echogenic replica tissue layer. A lattice having a looser “weave” results in less spatial density of higher acoustic impedance material relative to the amount of lower acoustic impedance material, resulting in a more hypo-echogenic replica layer. This pitch of the lattice can be varied across the replica layer 205 in three dimensions to achieve varying echogenicities across and through the volume of the replica tissue layer 205. Such lattice structures are described further in relation to FIG. 3E. The addition of a lattice structure, in addition to providing a means for modulating echogenicity, can help reduce the risk of tearing or otherwise damaging the echogenic organ replica 130 during manipulation and handling. In still other implementations, the higher acoustic material depositions can be made in clusters of microbeads, rather than in a substantially even distribution.

As further shown in FIG. 2, the portion of the echogenic organ replica 130 shown in cut-away view 200A includes a middle replica tissue layer 205b. The middle replica tissue layer 205b can be formed using suspensions of higher acoustic impedance materials in lower acoustic impedance materials, or with lattices of higher acoustic impedance materials surrounded by lower impedance materials. Given that the tissue structure of the middle replica tissue 205b is different than that of the outer replica tissue layer 205a, the density of the higher acoustic material suspended or distributed in the lower acoustic material or the pitch of the lattice used in forming the middle layer may be different than that employed in forming the outer replica tissue model 205a to achieve different echogencities for the two tissue replica layers 205a and 205b. In addition, different material may be selected to provide different mechanical properties for each respective layer.

As shown in FIG. 2, the portion of the echogenic organ replica 130 shown in cut-away view 200A may also include an inner tissue replica layer 205c. As described above in relation to the outer and middle tissue replica layers 205a and 205b, the inner material layer 205c may be formed from suspensions or lattices of materials with varying acoustic impedances to create echogenicities that mimic the in vivo echogenicity of the tissue replica layer 205c.

In some implementations, particularly in implementations in which tissue replica layers are formed from suspensions of higher acoustic impedance materials in lower acoustic impedance materials, adjacent tissue replica layers may be separated by a thin (on the order one hundred to three hundred microns thick) layer of higher acoustic impedance material. Such material tends to be stronger, more mechanically stable, and not susceptible to removal during cleaning procedures. As a result, such layers help maintain the structural integrity of such organ replicas.

FIGS. 3A-3D are diagrams showing a plurality of echogenic organ replica material arrangements according to some implementations that may form an echogenic organ replica 120 or portions thereof.

FIG. 3A illustrates a plurality of regions, for example regions A, B, C, D, and E. Each of the plurality of regions shown in FIG. 3A represent an exemplary material distribution through the thickness of a replica tissue layer of an organ replica 130 or portions thereof. It will be appreciated that a large variety of material distributions may be deposited across the thickness of a replica tissue layer by the additive manufacturing system 125. In some implementations, multiple layers with additional or alternate material distributions may be arranged to form the echogenic organ replica 130 or portions thereof. The plurality of regions shown in FIG. 3A are shown in a cross-sectional view through the wall of a replicated tissue. A legend of materials is provided at the bottom of FIG. 3A. A scale of echogenicity is provided on the right side of FIG. 3A to describe the degree of acoustic reflectivity associated with each region resulting from the amount and spatial distribution of higher acoustic impedance materials that are included within the respective region.

As shown in FIG. 3A, the material arrangements shown in diagram 300A includes a plurality of materials, for example one or more materials such as a lower acoustic impedance material and a higher acoustic impedance material. The plurality of materials in diagram 300A illustrate multiple exemplary configurations or material arrangements of materials formed by an additive manufacturing system, such as the additive manufacturing system 125, based on one or more received data files 120 as shown in FIG. 1. The configuration of materials shown in FIG. 3A may be formed by the additive manufacturing system 125 by depositing discrete amounts of the individual materials, such as lower acoustic impedance materials and higher acoustic impedance materials.

As shown in FIG. 3A, five arrangements of one and/or two materials are illustrated. In region A, only lower acoustic impedance material is included in the region. As described in the echogenicity scale on the right side of FIG. 3A, a material arrangement of solely lower acoustic impedance materials would result in a region with maximally transmissive acoustic properties. In region B, the material arrangement includes a block of higher acoustic impedance material on either side of a continuous deposit of four blocks of lower acoustic impedance material. The resulting echogenicity of region B would be higher than region A as a result of introducing higher acoustic impedance material into the region B, creating interfaces between higher acoustic impedance materials and lower acoustic impedance materials, where acoustic energy scatters or reflects, increasing the echogenicity of the region. In region C, the material arrangement includes a volume of higher acoustic impedance material deposited between three repeating volumes of lower acoustic impedance material. The resulting echogenicity of region C is greater than regions A and B due to the more frequent (lesser spacing) interfaces between materials of differing acoustic impedances. In layer E, the material arrangement includes a single volume of higher acoustic impedance material deposited directly between single volumes of lower acoustic impedance material in a repeating manner. The resulting echogenicity of region E is greater than the echogenicity of any of layers D, C, B, and A due to the highest frequency/minimal spacing between interfaces of materials of different acoustic impedances.

FIG. 3B includes two exemplary diagrams, 300B-1 and 300B-2, illustrating the effect of distributing or encapsulating higher acoustic impedance materials within lower acoustic impedance materials and the resulting acoustic reflectivity and transmissivity associated with a plurality of materials distributed within the layers. In some implementations, multiple layers with additional or alternate material distributions may be arranged to form the echogenic organ replica 130 or portions thereof. The plurality of layers shown in diagrams 300B-1 and 300B-2 of FIG. 3B are shown in a horizontal cross-sectional view. In each of the diagrams an ultrasound transducer transmits acoustic energy downward, as shown by the downward arrows emanating from the ultrasound transducer. The acoustic energy transmitted from the ultrasound transducer penetrates layer A first, followed by layer B, and finally penetrating layer C last. A legend of materials is provided below each diagram 300B-1 and 300B-2. A scale of acoustic reflectivity and acoustic transmissivity is provided on the right side of each diagram. The size of the arrow corresponds to the magnitude or degree in which the property is present in the combination of material layers. For example, a large arrow representing acoustic reflection indicates the combination of material layers produces a greater amount or large degree of acoustic reflection, while a smaller arrow indicates the combination of material layers produces a smaller amount or lesser degree of acoustic reflectivity. The same interpretations of arrow size described in relation to acoustic reflectivity may be similarly applied in regard to acoustic transmissivity. The orientation of the arrows (e.g., an arrow pointing up or an arrow pointing down) illustrates the direction in which the acoustic energy is radiated. The acoustic energy may be reflected from the combination of materials back toward the ultrasound transducer (e.g., shown using an upward arrow) or the acoustic energy may be transmitted through the combination of materials away from the ultrasound transducer (e.g., shown using a downward arrow). Or, in some cases, the acoustic energy may be scattered, due to Rayleigh scattering, due to the presence of higher acoustic impedance materials with dimensions that are much smaller than the ultrasound wavelength in the surrounding material.

As shown in diagram 300B-1 of FIG. 3, a material arrangement including a plurality of materials arranged in three layers is shown. Layers A and C include solely lower acoustic impedance material, while layer B includes two volumes of higher acoustic impedance material. The two volumes are of higher acoustic impedance material form cuboid microbeads within the volume of lower acoustic impedance material. As seen in the resulting acoustic reflectivity scale, a relatively small amount of the acoustic energy emanating from the ultrasound transducer is reflected while a large degree of the acoustic energy from the ultrasound transducer is transmitted through the combination of materials formed by the three layers in diagram 300B-1. The result is due to the relatively small amount of higher acoustic impedance materials within a larger body of lower acoustic impedance materials, producing a lesser degree of acoustic reflection (e.g., a lower echogenicity). The combination of materials results in fairly high transmission of acoustic energy through the combination of material layers because of the smaller size and lack of continuity of the interface between the lower acoustic impedance material and the higher acoustic interface materials.

As shown in diagram 300B-2 a material arrangement including a plurality of materials arranged in three layers is shown. Similar to diagram 300B-1, the material arrangement shown in diagram 300B-2, layers A and C include solely lower acoustic impedance material. However, in diagram 300B-2 includes five volumes of higher acoustic impedance material distributed within or encapsulated by the lower acoustic impedance material. The five continuous volumes form an ovoid microbead within the volume of lower acoustic impedance material. Increasing the amount or concentration of higher acoustic impedance distributed within lower acoustic impedance material results in a greater degree of acoustic reflection of the applied acoustic or ultrasound energy through the combination of materials formed by the three layers due to the increased area of acoustic impedance discontinuities (i.e., the larger amount of area that constitutes an interface between materials of different acoustic impedances).

The material arrangement 300B-2 shown in FIG. 3B also exhibits an echogenic anisotropy which can be valuable for replicating in vivo tissue response to ultrasound. For example, certain human tissues, such as tendons, fetal brain tissue, kidney tissues, and others all demonstrate an anisotropic ultrasound aspect. Such anisotropy can be used, for example, in diagnosing certain pathologies, for example perventricular leukomalacia in fetal brain tissue. The ability to replicate such anisotropy can be useful in creating tissue models that clinicians or medical students can use in training to learn how to diagnose such conditions.

The anisotropy exhibited by the arrangement 300B-2 results from the volume of higher acoustic impedance material being only one unit thick vertically on the page, while being five units thick horizontally on the page. Accordingly, as shown, with the ultrasound transducer positioned above the material arrangement 300B-2, the ultrasound wave front encounters a structure of high acoustic impedance material that is five volumes across. If the placement of the ultrasound transducer were rotated about the arrangement 300B-2 by 90° so that ultrasound energy were transmitted into the arrangement 300B-2 from the side rather than from the top, the ultrasound response would be significantly less pronounced, as the wave front would encounter a high acoustic impedance structure only one unit across. That is, more acoustic energy would be able to pass through the material arrangement from the side than from the top or bottom.

FIG. 3C shows arrangements of a plurality of materials arranged in five regions. The five regions shown in FIG. 3C include a plurality of materials having different acoustic impedance properties, as well as different mechanical properties. For example, the plurality of materials includes two higher acoustic impedance materials, each having a different mechanical property, for example an elastic higher acoustic impedance material and a stiff higher acoustic impedance material and a lower acoustic impedance material. The two higher acoustic impedance materials may be, e.g., two PolyJet™ materials with different elasticities. In other implementations, other higher acoustic impedance materials can be used for either the stiff high acoustic impedance material or the elastic high acoustic impedance material without departing from the scope of the disclosure.

FIG. 3D is a diagram showing an echogenic organ replica material arrangement according to some implementations. As shown in diagram 300E of FIG. 3D, a plurality of materials is illustrated as arranged in a single layer viewed from a top-down perspective. The material arrangement shown in diagram 300E is an arrangement of materials to be deposited to form a lattice structure within one or more layers of the echogenic organ replica 130. The plurality of materials includes lower acoustic impedance materials and higher acoustic impedance materials. In some implementations, although not explicitly shown, the plurality of materials may also include one or more material mixtures as described above wherein higher acoustic impedance material is suspended within lower acoustic impedance materials that may or may not possess a stiff mechanical property or an elastic mechanical property.

As shown in FIG. 3D, a lattice of higher acoustic impedance material is distributed within a lower acoustic impedance material such that the higher acoustic impedance higher acoustic impedance material is encapsulated by the lower acoustic impedance material. The lattice structure may be configured such that the pitch varies in one or more locations of the material arrangement thereby varying the local echogenicity of the material arrangement. For example, FIG. 3D illustrates two different pitches, e.g., pitch A, a smaller horizontally oriented pitch, shown on the top left side of diagram 300E, and pitch B, a larger horizontally oriented pitch, shown on the top right side of diagram 300D. Pitch is a center-to-center measurement of the distance or space between repeating elements, such as repeating volumes of higher acoustic impedance material to be deposited in a lattice configuration or arrangement as shown in diagram 300E to form a portion of an echogenic organ replica 130. The material arrangement may include a consistent pitch throughout a portion of the echogenic organ replica or the material arrangement may include different pitches at one or more locations of the material arrangement. The pitch may vary in two dimensions, for example across a tissue surface, or in three dimensions, i.e., both across the surface and through the thickness of a tissue or organ replica. The resulting echogenic organ replica 130 may therefore include one or more regions with a consistent pitch (and corresponding echogenicity) and one or more regions with a varying pitch (and varying echogenicity).

For example, as shown in FIG. 3D, the smaller horizontal pitch A is configured such that a single volume of lower acoustic impedance material is deposited between two adjacent volumes of higher acoustic impedance material. As further shown in FIG. 3D, the larger horizontal pitch B is configured such that three volumes of lower acoustic impedance material are deposited between two adjacent volumes of higher acoustic impedance material. In this way, the lattice structure may be configured within the echogenic organ replica 130 such that at a first location the echogenic organ replica 130 may have a first pitch resulting in a first echogenicity while a second location may have a second or different pitch resulting in second or different echogenicity. The pitch may vary at the one or more locations of the echogenic organ replica 130 in order to achieve an arrangement of materials simulating the echogenicity of one or more corresponding locations of the in vivo organ being replicated. In some implementations, in addition to the horizontal pitch varying, the vertical pitch dimension at one or more locations of the organ replica 130 can also vary or be adjusted to replicate the echogenic properties at one or more locations of the in vivo organ being replicated. In addition, as indicated above, the pitch may vary in a third dimension (i.e., into or out of the plane of the Figure) when the lattice is a three-dimensional lattice.

The lattice structure in FIG. 3D demonstrates how higher acoustic materials can be deposited as microfibers. Each microfiber is a continuous string of volumes of higher acoustic impedance material.

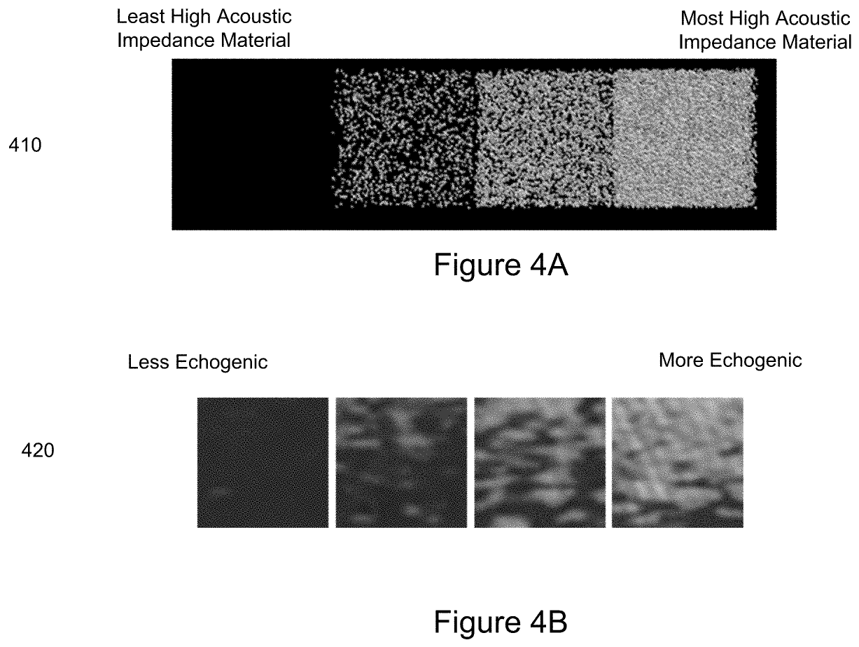

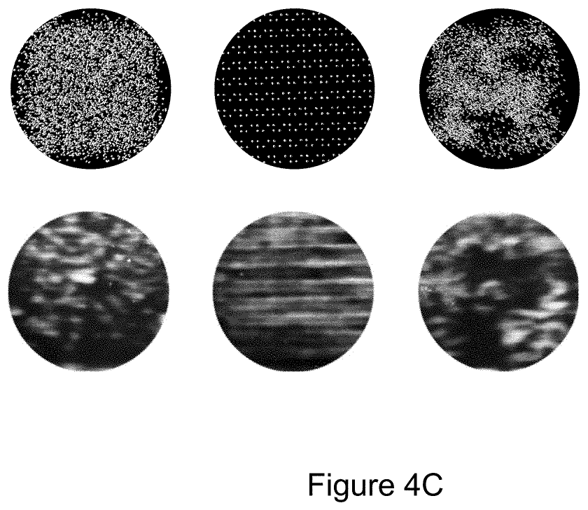

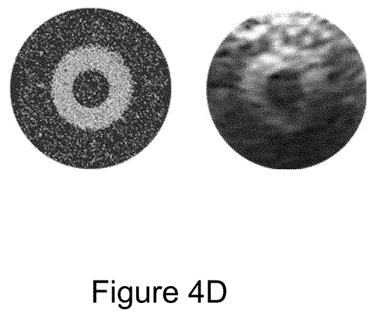

FIG. 4A is a diagram showing a set of organ replica material distributions 410 according to some implementations. In FIG. 4A, four different material distribution samples are shown in set 410. The four different material distributions samples shown in set 410 illustrate the resulting spatial density of distributing a higher acoustic impedance material within at least one lower acoustic impedance material. As shown in set 410, each of the four material distribution samples may represent one or more voxels. A voxel is an elementary volumetric element associated with a three-dimensional set of nodes which partition a region of space region (e.g., the space encompassed by the organ or portions of the organ to be replicated) in a volumetric model of the organ or portions of the organ to be replicated. Each voxel may include a material mixture with a given concentration of higher acoustic impedance material distributed or encapsulated within a volume of lower acoustic impedance material such that the resulting spatial density of the higher acoustic impedance material varies among the different voxels. The material mixture of a voxel may be within a single deposition of material (e.g., a mixture of nano-particles of high-acoustic impedance material suspended in a single droplet of predominantly lower acoustic impedance material from a 3D printer print head) or across multiple independent material deposits, with a given spatial distribution of higher acoustic impedance material depositions within a larger body of lower impedance material depositions.

As further shown in FIG. 4A, the brighter points shown in each of the four different material distribution samples in series 410 represent an amount of higher acoustic impedance material. The dark background represents the amount of at least one lower acoustic impedance material within which the amounts of higher acoustic impedance material are distributed. In some implementations, the higher acoustic impedance material may be suspended or distributed within the at least one lower acoustic impedance material as a plurality of microbeads or microfibers. In some implementations, the microbeads or microfibers may have a diameter (or smallest dimension if not spherical) between 0.01 mm and 1.0 mm. As shown in the set 410 of FIG. 4A when viewed from left to right, the range of four material distribution samples illustrate the resulting spatial densities achieved when distributing or encapsulating higher acoustic impedance material within the at least one lower acoustic impedance material at different concentrations. As shown in FIG. 4A, the resulting spatial density of the material distribution samples of the set 410 increases (from left to right) as the concentration of the higher acoustic impedance material distributed or encapsulated within the at least one lower acoustic impedance material increases. For example, the left-most image includes no (or 0%) higher acoustic impedance material and is formed solely from lower acoustic impedance material. In the second image from the left, 1.0% of the material distribution is made up of a higher acoustic impedance, and the remainder is lower acoustic impedance material. In the third image from the left, 4.0% of the material distribution is made up of a higher acoustic impedance, and the remainder is lower acoustic impedance material. In the right-most image, 6.0% of the material distribution is made up of a higher acoustic impedance, and the remainder is lower acoustic impedance material. In various implementations, the spatial density of higher acoustic impedance material may be as high as 10%-20% or more of the volume of the structure. In some implementations, the spatial density of higher acoustic material ranges from 0%-10% of the volume of a given sample of the material.

FIG. 4B is a series of ultrasound images 420 illustrating the echogenic results corresponding to interrogating the set of organ replica material distributions 410 shown and described in relation to FIG. 4A.

As shown in FIG. 4B, series 420, when viewed from left to right, illustrates the increasing echogenicity associated with distributing or encapsulating increasing amounts of higher acoustic impedance material within at least one lower acoustic impedance material. For example, as viewed at the far left of series 420 labeled “least echogenic”, a material distribution that includes minimal amounts of higher acoustic impedance material encapsulated or distributed within at least one lower acoustic impedance material, produces a less pronounced (and most dispersed) ultrasound echo and reflects less ultrasound energy than a material distribution that includes a greater amount of higher acoustic impedance material suspended or distributed within the at least one lower acoustic impedance material, as shown at the far right and labeled “most echogenic”. As viewed at the far right of series 420, a material distribution that includes greater amounts of higher acoustic impedance material encapsulated or distributed within at least one lower acoustic impedance material, produces a more pronounced (concentrated) ultrasound echo, as shown by increased reflection of the ultrasound energy.

As further shown in FIG. 4B, series 420, which corresponds to material distribution set 410 shown in FIG. 4A, similarly shows increasing echogenicity (viewed from left to right) as the concentration of higher acoustic impedance material encapsulated or distributed within the at least one lower acoustic impedance material increases. By adjusting the concentration or resulting spatial density of the higher acoustic impedance material distributed or encapsulated within the at least one lower acoustic impedance material it is possible to achieve a desired echogenicity at one or more locations of the echogenic organ replica 130. In this way, the echogenicity of in vivo organ tissues can be effectively replicated in one or more locations of an echogenic organ replica.

FIG. 4C demonstrates how the ultrasound aspect of an echogenic organ replica can also be modulated by altering the specific arrangement of higher acoustic material impedance materials within a volume of lower acoustic impedance materials. The top row of images in FIG. 4C depict CAD models of depositions various higher acoustic impedance deposition patters, whereas the lower row of pictures show the actual ultrasound response obtained from imaging a material made using such deposition pattern. As can be seen in the left-most pair of images, a relatively consistent, but random distribution of higher acoustic impedance material depositions results in a relatively consistently cloudy ultrasound image. A structured deposition of higher acoustic impedance material, with the higher acoustic impedance materials deposited in rows, results in an ultrasound image in which such rows are discernable, as can be seen in the middle pair of images. The right-most pair of images shows how a clustered deposition of higher acoustic impedance materials can lead to a different ultrasound aspect than a more consistent distribution pattern. These, and other patterns can be employed to replicate the various ultrasound aspects expected when imaging actual in vivo tissues.

FIG. 4D shows how more defined local variations of high acoustic impedance material can achieve defined ultrasound imaging results. The left hand image depicts a CAD model of higher acoustic impedance material depositions within lower acoustic impedance material. The CAD model includes alternating concentric rings of having different spatial densities of higher acoustic impedance materials. The brighter rings correspond have a higher spatial density of higher acoustic impedance material deposition than the darker rings. In some implementations, each bright dot in the CAD model corresponds to a deposited microbead of higher acoustic impedance material. The right image shows the ultrasound response to a structure fabricated according to the CAD model. As can be seen in FIG. 4D, the rings are clearly distinguishable in the ultrasound image.

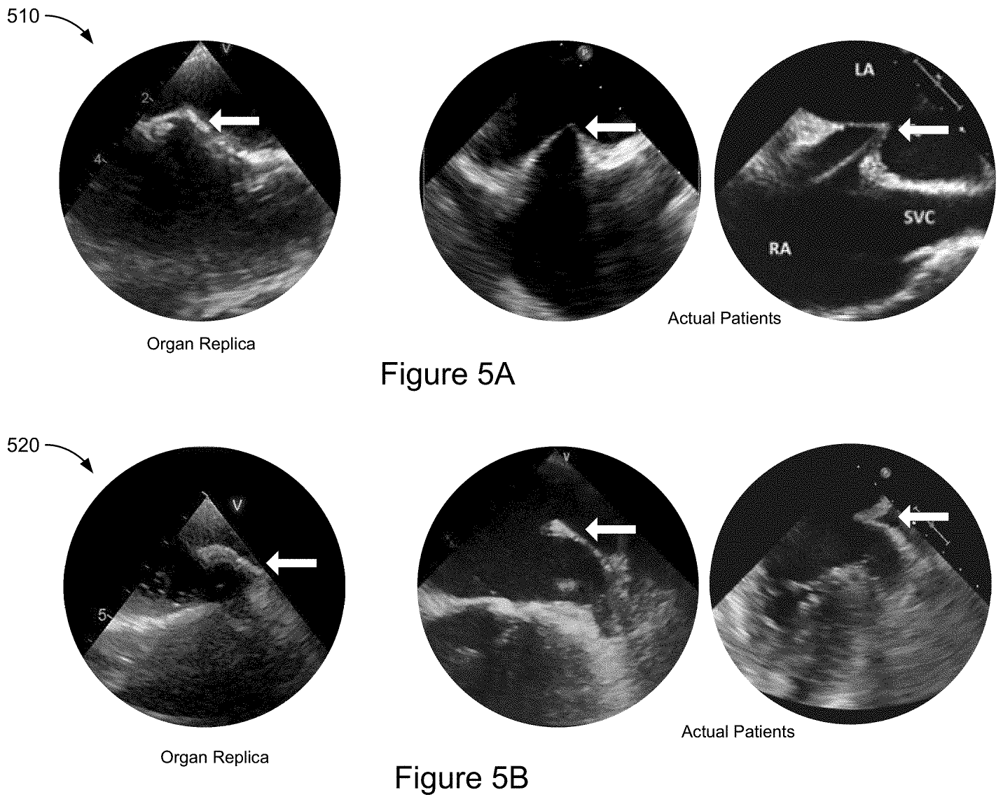

FIG. 5A is a series of ultrasound images 510 comparing the echogenicity of a patient's organ replica 130 fabricated using the systems and according to the methods disclosed herein with the echogenicity of a patient's in vivo organ in response to tissue tenting. Tissue tenting occurs when an object creates a force upon a tissue with a catheter causing the tissue to stretch or “tent” in response to the applied force. For example, when performing a transseptal puncture during one of a transseptal transcatheter intracardiac intervention procedure, a medical device object may apply pressure to the cardiac tissue at the puncture site. When viewed using ultrasound imaging, the cardiac tissue can be seen respond to the applied pressure by stretching or “tenting” at the puncture site as the pressure is applied to the tissue by the medical device object. As shown in series 510, a comparison between an ultrasound image of an echogenic organ replica 130 of the patient's heart and ultrasound images of the patient's heart in in vivo conditions is provided. The echogenicity of the organ replica 130 can be seen to replicate the echogenicity of the patient's heart under in vivo conditions. An arrow is used to illustrate the site of the tented tissue that can be seen in the ultrasound of the echogenic organ replica 130 as well as the ultrasound images of the patient's heart under in vivo conditions. A medical practitioner wishing to practice a transseptal puncture for a specific patient's heart may perform the transseptal transcatheter intracardiac intervention procedure with the echogenic organ replica 130 replicating of the echogencity of the patient's heart under in vivo conditions.

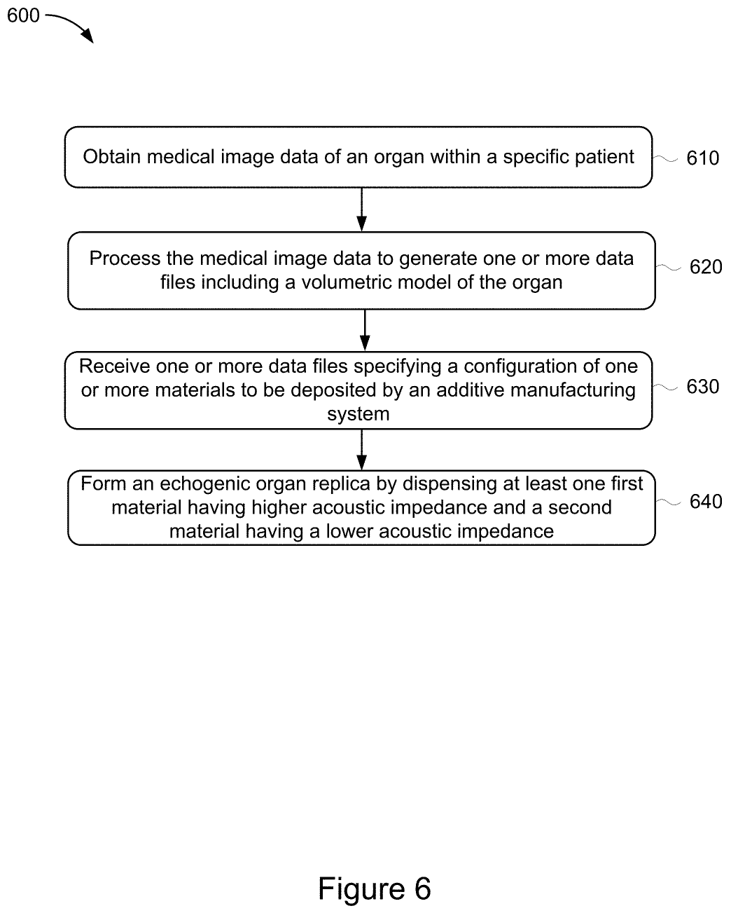

FIG. 5B is a series of ultrasound images 520 comparing the echogenicity of a patient's echogenic organ replica 130 fabricated using the systems and according to the methods disclosed herein with the echogenicity of the patient's in vivo organ in response to appendage detection. Appendage detection may be performed by a medical practitioner using ultrasound imaging to detect one or more anatomic appendages, for example an atrial appendage that may be present inside the heart of a specific patient. As shown in series 520, a comparison between an ultrasound image of an echogenic organ replica 130 of the patient's heart and ultrasound images of the patient's in vivo heart is presented. The series of images 520 show that the atrial appendage detected in the patient's organ under in vivo conditions has been replicated in the echogenic organ replica 130. An arrow is used to illustrate the appendage in the ultrasound of the echogenic organ replica 130 as well as the ultrasound images of the patient's organ under in vivo conditions. Based on medical image data 115 obtained for an organ of the patient, the echogenic organ replica 130 was formed according to the method 600 described in relation to FIG. 6. The echogenic organ replica 130 ultrasound image shown in series 530 illustrates that the echogenic organ replica 130 possesses echogenic properties replicating the echogenicity of the patient's organ under in vivo conditions. The echogenic organ replica 130 may provide a medical practitioner practicing an atrial appendage intervention procedure using ultrasound imaging with a greater understanding of various anatomical structures inside the heart that might otherwise not be made visible in non-echogenic organ replicas. For example, the echogenic organ replica 130 may allow a medical practitioner to view anatomic structures, such as appendages, which may be located behind other organs, organ tissues, fatty tissue, or membranes when using ultrasound imaging to practice a specific medical procedure. The echogenic organ replica 130 enables the medical practitioner to simulate the specific procedure using the same ultrasound imaging methods that would be used in the specific medical procedure in real life, thereby improving the confidence of the medical practitioner and reducing the risk to the patient.

FIG. 6 is a flow chart representing an example method 600 of manufacturing an echogenic organ replica 130 according to some implementations. The method includes obtaining medical image data of an organ within a specific patient (stage 610). The method also includes processing the medical image data to generate one or more data files including a volumetric model of the organ (stage 615). The method includes receiving one or more data files specifying a configuration of one or more materials to be deposited by an additive manufacturing system (stage 630). The method also includes forming an echogenic organ replica by dispensing at least one first material having lower acoustic impedance properties and a second material having higher acoustic impedance properties (stage 640).

At stage 610, medical image data of an organ within a specific patient is obtained. The medical image data of the organ may be obtained using common medical imaging modalities such as X-ray radiography, X-ray rotational angiography, MRI, CT scanning, ultrasound imaging (2D or 3D), or nuclear medicine functional imaging techniques such as positron emission tomography and single-photon emission computed tomography. For example, as shown in FIG. 1, medical image data 115 is obtained using a medical imaging system 105, such as a CT scanner, or an ultrasound imaging system 110. The medical image data 115 may be obtained for an organ within a specific patient or for part of a larger organ. For example, the organ may be a heart or an artery. The medical image data 115 may also include data associated with organs surrounding or located in close proximity to the organ being imaged such as bones, joints, fatty tissue, glands, or membranes which may exert mechanical feedback on the organ to be replicated.

At stage 620, the medical image data 115 is processed to generate one or more data files 120 including a volumetric model of the organ. The medical image data 115 is processed to generate a volumetric model of the specific organ to be replicated as the echogenic organ replica 130. The volumetric model is generated by converting the medical image data 115 into a three dimensional data model describing the anatomic characteristics of the organ to be replicated. The anatomic characteristics may include various linear dimensions, volume dimensions, thicknesses, as well as other characteristics of the organ being replicated, such as tissue echogenicity. Such characteristics can be derived directly from the medical imaging data 115 collected (e.g., from ultrasound images), or indirectly by reference to one or more databases or other electronic data sources of anatomical knowledge that stores reference information about representative tissue characteristics of various tissues in the body. The volumetric model includes a three dimensional set of nodes which define a plurality of elementary volumetric elements or voxels partitioning a space region (e.g., the space encompassed by the organ or portions of the organ) modeled by the volumetric model. The elementary volumetric elements may be defined as shapes of a tetrahedron, a pyramid, a triangular prism, a hexahedron, a sphere, or an ovoid. The volumetric model may be generated from a three dimensional surface mesh of the organ to be replicated which captured in the medical image data 115. In some implementations, the volumetric model may be generated by performing volumetric model generation on the surface mesh. In some implementations, the volumetric model is generated by performing finite-element volumetric model generation on the medical image data 115. In some implementations, the volumetric model is further processed to generate a deformed volumetric model of the organ to be replicated. In these implementations, the deformed volumetric model replicates the loads and constraints imposed on the in vivo organ tissue of a specific patient by one or more organ tissues surrounding the specific patient's in vivo organ tissue.

Defining the three dimensional set of nodes and the elementary volumetric elements or voxels associated with the imaged organ allows a plurality of materials to be assigned to each voxel so that the additive manufacturing system 125 may form the echogenic organ replica 130 such that the echogenic properties of the in vivo organ tissue at one or more locations are accurately replicated in the corresponding locations of the echogenic organ replica 130. The assigned materials may include materials of differing acoustic impedance values, such as higher acoustic impedance materials, lower acoustic impedance material, or mixtures or suspensions of materials having different acoustic impedances.

Material assignment is performed using a cost function to minimize the error between the desired echogenic properties (determined based on the medical image data 115 or from electronic databases or data sources storing representative tissue characteristic data) and the resulting echogenic properties of the combination of one or more of the materials selected for deposition in a location corresponding to a given voxel or cluster of voxels of the volumetric model. In some embodiments, the cost function may include additional cost functions, for example a cost function to minimize the error associated with the elastic material properties or other mechanical material properties of the organ being replicated. In these embodiments, material assignment may be achieved by solving the cost function using a joint search to minimize the sum of the errors between the mechanical material properties and the echogenicity material properties. In some implementations, weights may be applied to the respective constituent cost functions based on the desired application. For example, it may be desirable to apply a higher weight to the cost function associated with mechanical material properties when accurately simulating echogenicity in the organ replica 130 is less important. Alternatively, it may be important to weight the cost function associated with echogenic material properties higher in situations where it is critical to accurately simulate echogenicity in the organ replica 130. After performing a joint search as described above, a final volumetric model may be generated.

In some implementations, as an alternative to a joint search method, a predetermined number of best fitting echogenic property models could be evaluated using a mechanical property cost function to select an overall best fitting model. Additionally, or alternatively, a predetermine number of best fitting mechanical property models could be evaluated using an echogenicity cost function to identify an overall best fitting model. In some implementations, the cost function may include constraints to prevent aspects of the volumetric model from being assigned specific materials. For example, a constraint could be implemented to require lower acoustic impedance materials formed from sacrificial material to be fully encapsulated within one or more higher acoustic impedance materials.

The object materials to be assigned to each voxel that were determined as a result of applying the cost function(s) may be selected from a database of object materials. In some implementations, a particular material may be selected based on the results of minimizing a cost function for a given region (e.g., a cluster) or plurality of elementary volumetric elements of the volumetric model.

As a result of processing the medical image data 115 of the specific patient's organ one or more data files 120 as shown in FIG. 1 are generated. In some implementations, the one or more data files 120 may be generated by a computing device co-located with the medical imaging system 105. In some implementations, the one or more data files 120 may be processed remotely from the medical imaging system 105. For example the medical image data 115 may be stored in a database or in a cloud computing environment and transmitted to a remotely located computing device to process the medical image data 115 in order to generate the one or more data files 120. In some implementations, processing the medical image data 115 includes converting the medical image data 115 from a data or file format that is specific to the particular medical imaging modality used to obtain the medical image data 115 into a data or file format that is compatible with an additive manufacturing system 125. For example, the medical image data 115 may be processed and converted into one or more STL data files 120 shown in FIG. 1 or other additive manufacturing system compatible file format. The STL file format may be utilized by the additive manufacturing system 125 to generate a 3D echogenic organ replica 130 based on the volumetric model included in the one or more data files 120.

At stage 630, the method further includes receiving one or more data files 120 specifying a configuration of one or more materials to be deposited by an additive manufacturing system 125. The one or more data files 120 may define an arrangement or configuration of a plurality of echogenic and non-echogenic materials (or higher acoustic impedance and lower acoustic impedance materials) to be deposited by the additive manufacturing system 125 based on the processing performed in stage 620. For example, based on the plurality of materials assigned to each voxel of the volumetric model included in the one or more data files 120, the additive manufacturing system 125 may determine the arrangement of one or more materials to be deposited in one or more layers to form the organ replica 130.

At stage 640, the additive manufacturing system 125 forms the echogenic organ replica 130 by dispensing at least one material having lower acoustic impedance properties and a second material having higher acoustic impedance properties. The additive manufacturing system 125 dispenses the plurality of materials to form the echogenic organ replica 130. The plurality of materials includes at least one lower acoustic impedance material and a higher acoustic impedance material. The two materials may be dispensed simultaneously as a suspension of the higher acoustic impedance material within the lower acoustic impedance material, or as separate depositions of higher acoustic impedance material and lower acoustic impedance materials. Based on the configuration of materials assigned to each voxel of the volumetric model included in the one or more data files 120, the additive manufacturing system 125 dispenses the appropriate material determined for a given elementary volumetric element defined in the volumetric model of the organ to be replicated. For example, the additive manufacturing system 125 dispenses amounts of the at least one hypo-echogenic materials at locations in the echogenic organ replica 130 which map or correspond to the same locations in the volumetric model that were determined to be less echogenic areas or regions based on the medical image data 115 or a an electronic tissue characteristic data source. Similarly, hyper-echogenic materials (e.g., a suspension with a higher density of high acoustic impedance material) may be dispensed by the additive manufacturing system 125 at locations in the echogenic organ replica 130 which correspond to the same locations in the volumetric model that were determined to be more echogenic.

There need not be a one-to-one correspondence between a voxel and a given material deposition. A voxel is a logical construct which can be processed by an additive manufacturing device to determine an appropriate set of independent material depositions. For example, some volumetric models may be generated with lower resolution than a print-resolution of a 3D printer used to print the echogenic organ replica 130. In such situations, the 3D printer may make multiple deposits of material to generate a single voxel. For example, in some implementations, each voxel may correspond to a 3×3×3, 4×4×4, 5×5×5, or other sized cuboid of material depositions. In other implementations, voxels may translate into ovoid or other shaped depositions, rather than cuboid depositions. The 3D printer used to fabricate the echogenic organ replica 130 may translate an echogencity value assigned to each voxel to an appropriate pattern of material depositions within a given a corresponding cuboid or ovoid deposition. In other implementations, each voxel corresponds to a single material deposition, which may have a spherical, ovoid, rectangular or other regular or irregular shape depending on the equipment used to make the deposition. The at least one material having lower acoustic impedance properties and the second material having higher acoustic impedance properties may be dispensed by the additive manufacturing system 125 using casting, 3D printing, mechanical linkages of disparate materials and material deposition manufacturing. A variety of additive manufacturing processes may be utilized by the additive manufacturing system 125 to form the echogenic organ replica 130 including binder jetting, directed energy deposition, material jetting, power bed fusion, fused deposition modeling, laser sintering, stereolithography, photopolymerization, and continuous liquid interface production. In some implementations, 3D printers using PolyJet Matrix™ technology (Stratasys, Ltd., Eden Prairie, Minn.) may be used to simultaneously dispense a plurality of materials having different elastic and acoustic impedance properties to form an echogenic organ replica 130 with varying elastic and echogenic properties at one or more locations. In some implementations, the at least one material having higher acoustic impedance properties includes a polymerized material, such as PolyJet material having a polymerized density of 1.18-1.21 g/cm³. In some implementations, the lower acoustic impedance includes a hydrogel with acoustic properties similar to water. In some implementations, the lower acoustic impedance material includes a non-polymerized material such as water, a gel, an ion, or a bio-molecule.

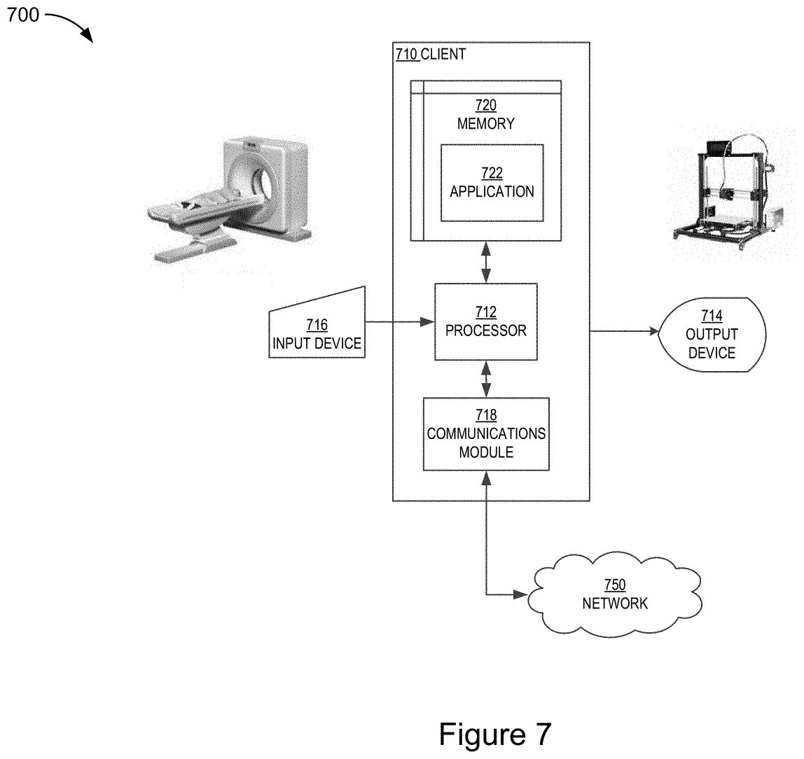

FIG. 7 is a block diagram illustrating a general architecture for a computer system 700 that may be employed to implement elements of the systems and methods described and illustrated herein, according to an illustrative implementation, such as one or more computer systems associated with the CT scanner 105, the ultrasound imager 110, or the additive manufacturing system 125 shown in FIG. 1.

In broad overview, the computing system 700 includes at least one input device 716, and at least one output device 714. The computing system 700 further includes at least one client computing device 710. The client computing device 710 includes a processor 712 for performing actions in accordance with instructions and one or more memory devices 720 for storing instructions and data. The one or more memory devices 720 are further configured to include application 722. The one or more processors 712 are in communication, via a communication module 718, with at least one network 750.

In more detail, the processor 712 may be any logic circuitry that processes instructions, e.g., instructions fetched from the memory 720. In many embodiments, the processor 712 is a microprocessor unit or special purpose processor. The client computing device 710 may be based on any processor, or set of processors, capable of operating as described herein to perform the methods described in relation to FIG. 6. The processor 712 may be a single core or multi-core processor. The processor 712 may be multiple processors. In some implementations, the processor 712 can be configured to run multi-threaded operations. In other implementations, the processor 712 may be configured to operate and communicate data in an environment of programmable logic controllers (PLC).

The memory 720 may be any device suitable for storing computer readable data. The memory 720 may be a device with fixed storage or a device for reading removable storage media. Examples include all forms of non-volatile memory, media and memory devices, semiconductor memory devices (e.g., EPROM, EEPROM, SDRAM, and flash memory devices), magnetic disks, magneto optical disks, and optical discs (e.g., CD ROM, DVD-ROM, and Blu-ray® discs).

The memory 720 also includes application 722 for controlling the method shown in FIG. 6. The application 722 may include one or more computer program products, e.g., one or more modules of computer program instructions encoded on a computer readable medium for execution by, or to control the operation of, the computer system 700 and according to any method well known to those of skill in the art. Memory 720 may also be used for storing temporary variable or other intermediate information during execution of instructions to be executed by processor 712.

Application 722 as discussed herein does not necessarily correspond to a file in a file system. Application 722 can be stored in a portion of a file that holds other programs or data (e.g., one or more scripts stored in a markup language document), in a single file dedicated to the program in question, or in multiple coordinated files (e.g., files that store one or more modules, subprograms, or portions of code). Application 722 can be deployed to be executed on one computer or on multiple computers that are located at one site or distributed across multiple sites and interconnected by a communication network, such as in a cloud-computing environment. The processes and logic flows described in this specification can be performed by one or more programmable processors executing one or more applications 722 to perform functions by operating on input data and generating output.

The communications module 718 manages data exchanges via a network interface card (not shown—also referred to as network interface driver). The communication module 718 handles the physical and data link layers of the OSI model for network communication. In some implementations, some of the network interface driver controller's tasks are handled by the processor 712. In some implementations, the communications module 718 is part of the processor 712. In some implementations, a client computing device 710 has multiple communications modules 718. The network interface ports configured in the network interface card (not shown) are connection points for physical network links. In some implementations, the communications module 718 supports wireless network connections and an interface port associated with the network interface card is a wireless receiver/transmitter. Generally, a client computing device 710 exchanges data with other network devices 750 via physical or wireless links that interface with network interface driver ports configured in the network interface card. In some implementations, the communications module 718 implements a network protocol such as Ethernet.

The computing system 700 also includes input device 716 and output device 714. For example, a client computing device 710 may include an interface (e.g., a universal serial bus (USB) interface) for connecting input devices 716 (e.g., a keyboard, microphone, mouse, or other pointing device), output devices 714 (e.g., video display, speaker, or printer), or additional memory devices (e.g., portable flash drive or external media drive). In some implementations, the input device 716 may include a medical imaging system such as the CT scanner 105 or ultrasound imaging device 110 shown in FIG. 1. In some implementations, the input device 716 may include a MRI system or device, a X-ray radiography device or system, or a nuclear medicine functional imaging system or device. In some implementations, the output device 714 may include an additive manufacturing system, such as additive manufacturing system 125 shown in FIG. 1.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs embodied on a tangible medium, i.e., one or more modules of computer program instructions, encoded on one or more computer storage media for execution by, or to control the operation of, a data processing apparatus. A computer storage medium can be, or be included in, a computer-readable storage device, a computer-readable storage substrate, a random or serial access memory array or device, or a combination of one or more of them. The computer storage medium can also be, or be included in, one or more separate components or media (e.g., multiple CDs, disks, or other storage devices). The computer storage medium may be tangible and non-transitory.

The operations described in this specification can be implemented as operations performed by a data processing apparatus on data stored on one or more computer-readable storage devices or received from other sources. The operations may be executed within the native environment of the data processing apparatus or within one or more virtual machines or containers hosted by the data processing apparatus.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

References to “or” may be construed as inclusive so that any terms described using “or” may indicate any of a single, more than one, and all of the described terms. The labels “first,” “second,” “third,” and so forth are not necessarily meant to indicate an ordering and are generally used merely to distinguish between like or similar items or elements.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. An echogenic organ replica, comprising:
a lower acoustic impedance material, and;
at least one higher acoustic impedance material distributed within the lower acoustic impedance material such that, at different locations of the echogenic organ replica, wherein the at least one higher acoustic impedance material is distributed within the lower acoustic impedance material with material distributions that vary in three dimensions through the organ replica, resulting in an organ replica whose echogenicity varies in three dimensions to replicate the three-dimensional variation of echogenicity associated with corresponding in vivo organ tissue.

2. The device of claim 1, wherein the at least one higher acoustic impedance material comprises a first higher acoustic impedance material and a second higher acoustic impedance material, wherein the second higher acoustic impedance material has a different elasticity than the first higher acoustic impedance material.

3. The device of claim 2, wherein the arrangement of the first higher acoustic impedance material and the second higher acoustic impedance material is such that the echogenic organ replica has, across its surface, substantially similar elasticity of corresponding locations of the in vivo organ tissue replicated by the echogenic organ replica in view of one or more organs surrounding the in vivo organ tissue.

4. The device of claim 1, wherein the at least one higher acoustic impedance material is distributed within the lower acoustic impedance material.

5. The device of claim 4, wherein the at least one higher acoustic impedance material is distributed within the lower acoustic impedance material as a plurality of microbeads distributed within the lower acoustic impedance material.

6. The device of claim 5, where in the smallest dimension of the microbeads is between 0.01 mm and 1.0 mm.

7. The device of claim 4, wherein the amount of higher acoustic impedance material distributed within the lower acoustic impedance material at a first location varies from the amount of higher acoustic impedance material distributed within the lower acoustic impedance material at a second location.

8. The device of claim 1, wherein the higher acoustic impedance material is distributed within the at least one lower acoustic impedance material such that the higher acoustic impedance material forms a lattice structure at the one or more locations of the echogenic organ replica.

9. The device of claim 8, wherein the lattice structure at a first location has a first pitch resulting in a first echogenicity and the lattice structure at a second location has a second pitch resulting in a second echogenicity.

10. The device of claim 1, wherein the lower acoustic impedance material comprises a non-polymerized material including at least one of water, a gel, an ion, or a bio-molecule.

11. The device of claim 1, wherein the at least one higher acoustic impedance material is distributed within the lower acoustic impedance material such that the resulting spatial density of higher acoustic impedance material within the lower acoustic impedance material ranges from about 0.1% to 10.0% of the volume of the lower acoustic impedance material at the one or more locations of the echogenic organ replica.

12. The device of claim 1, wherein the higher acoustic impedance material is distributed within the lower acoustic impedance material such that the spatial density of higher acoustic impedance material within the lower acoustic impedance material at a first location ranges from about 1.0% to 3.0% and the spatial density of higher acoustic impedance material within the lower acoustic impedance material at a second location is greater than 3.0%.

13. The device of claim 1, wherein the lower acoustic impedance material and the at least one higher acoustic impedance material comprise 3D printed materials.

14. The device of claim 1, wherein the in vivo organ tissue comprises organ tissue of one or more human or animal organs including a heart, a lung, a stomach, a urinary bladder, a bone, a lymph node, a larynx, a pharynx, muscle vasculature, a spinal column, an intestine, a colon, a rectum, or an eye.

15. A method of manufacturing an echogenic organ replica, comprising:
obtaining medical image data of an organ within a specific patient;
receiving, by an additive manufacturing system, one or more data files specifying a configuration of one or more materials to be deposited by the additive manufacturing system, and;
forming, by the additive manufacturing system, the echogenic organ replica by dispensing, based on the received one or more data files, at least one higher acoustic impedance material distributed within a lower acoustic impedance material such that, at different locations of the echogenic organ replica, wherein the at least one higher acoustic impedance material is distributed within the lower acoustic impedance material with material distributions that vary in three dimensions through the organ replica, resulting in an organ replica whose echogenicity varies in three dimensions to replicate the three-dimensional variation of echogenicity associated with corresponding in vivo organ tissue.

16. The method of claim 15, wherein one material of the at least one higher acoustic impedance material has a first elasticity and another material of the at least one higher acoustic impedance materials has a second elasticity different than the first elasticity.

17. The method of claim 15, wherein the at least one higher acoustic impedance material is distributed within the lower acoustic impedance material.

18. The method of claim 17, wherein the at least one higher acoustic impedance material is distributed within the lower acoustic impedance material as a plurality of microbeads distributed within the lower acoustic impedance material.

19. The method of claim 18, where in the smallest dimension of the microbeads is between 0.01 mm and 1.0 mm.

20. The method of claim 17, wherein the amount of the at least one higher acoustic impedance material distributed within the lower acoustic impedance material at a first location varies from the amount of higher acoustic impedance material distributed within the lower acoustic impedance material at a second location.

21. The method of claim 15, wherein the at least one higher acoustic impedance material is distributed within the lower acoustic impedance material such that the at least one higher acoustic impedance material forms a lattice structure at the one or more locations of the echogenic organ replica.

22. The method of claim 21, wherein the lattice structure at a first location has a first pitch resulting in a first echogenicity at the first location and the lattice structure at a second location has a second pitch resulting in a second echogenicity at the second location.

23. The method of claim 15, wherein the lower acoustic impedance material comprises a non-polymerized material including at least one of water, a gel, an ion, or a bio-molecule.

24. The method of claim 15, wherein the at least one higher acoustic impedance material is distributed within the lower acoustic impedance material such that the resulting spatial density of at least one higher acoustic impedance material within the lower acoustic impedance material ranges from about 0.1% to 10.0% of the volume of the lower acoustic impedance material at one or more locations of the echogenic organ replica.

25. The device of claim 15, wherein the at least one higher acoustic impedance material is distributed within the lower acoustic impedance material such that the spatial density of the at least one higher acoustic impedance material within the lower acoustic impedance material at a first location ranges from about 1.0% to 3.0% and the spatial density of the at least one higher acoustic impedance material within the lower acoustic impedance material at a second location is greater than 3.0%.

26. The method of claim 15, wherein local mechanical properties of the at least one higher impedance material and the lower acoustic impedance material vary to replicate mechanical feedback exerted on the organ being replicated by one or more organ tissues surrounding the in vivo organ tissue.

27. The method of claim 26, wherein the one or more organ tissues surrounding the organ being replicated, for which mechanical feedback is exerted on the organ, includes at least one of bones or joints.

28. The method of claim 15, wherein the organ comprises a part of a larger organ.

29. The method of claim 15, wherein the organ comprises an artery.

30. The method of claim 15, wherein the organ comprises a heart, a lung, a stomach, a urinary bladder, a bone, a lymph node, a larynx, a pharynx, muscle vasculature, a spinal column, an intestine, a colon, a rectum, or an eye.
